(19) United States
(12) Patent Application Publication
(10) Pub. No.: US 2009/0205511 A1
(43) Pub. Date: Aug. 20, 2009

(54) METHODS AND APPARATUS FOR ACCELERATING COOLING OF A COUNTERTOP DEEP FRYER

(76) Inventor: Lawrence J. Tienor, Eau Claire, WI (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/032,868

(22) Filed: Feb. 18, 2008

(51) Int. Cl. A47J 37/12; A23L 1/01; F28D 15/00

(52) U.S. Cl. 99/403; 426/665; 165/104.28

(57) ABSTRACT

A countertop deep fryer includes a cooking assembly and a cooling apparatus. The cooling apparatus accelerates the cooling process of heated cooking oil by directing a cooling air flow through an insulation gap defined between a basin and an exterior shell. The cooling air flow is introduced through an inlet opening in the exterior shell and heated air is discharged through an exhaust opening in the shell. The cooling assembly can include a fan assembly positioned proximate the inlet opening for forcing ambient air into the inlet opening.

### FIELD OF THE INVENTION

The present invention relates generally to food preparation apparatuses and, more specifically, to a deep fryer that creates an airflow to accelerate cooling of heated cooking oil.

### BACKGROUND OF THE INVENTION

A popular method of food preparation is deep frying. In deep frying, food is generally submerged in hot oil or cooking fat. Due to the high temperatures achieved by the hot cooking oil or fat during cooking, as well as a high conductivity of heat (as, for example, compared to water), the deep frying method of food preparation is able to significantly reduce cooking times, In addition, the taste associated with deep frying is considered a benefit by many consumers.

A number of different types of food preparation devices can be used to deep fry food, including pressure fryers and deep fryers. Deep fryers are currently well-known in the art and include devices developed for industrial and household applications such as, for example those disclosed in U.S. Pat. Nos. 5,029,519, 5,379,684, 5,586,486 and 6,823,772 as well as U.S. Patent Publication No. 2006/0196366 A1. Deep fryers generally include a basin for containing the oil and a heating element for heating cooking oil directly or heating the basin, which in turn heats the cooking oil. Current deep fryers often feature a basket for lowering and raising the food into and out of the heated cooking oil. Additional features may also include timers with audible alarms, automatic devices to raise and lower the basket out of and into the oil, measures to prevent food crumbs from becoming overcooked, ventilation systems, oil filters, and mechanical or electronic temperature controls.

An important characteristic of deep fryers is the ability to maintain an accurate and steady temperature. Although the ideal temperature of deep frying largely depends upon the type of food being cooked, in most cases, the temperature of the cooking oil should be between approximately 345° F. and approximately 400° F. At these high temperatures, potential risks can include inadvertent contact with the heated cooking oil, and a delay in properly disposing of the heated cooking oil.

Most household and some restaurant deep fryers are of the countertop variety. Countertop deep fryers are popular because of their mobility. Specifically, countertop deep fryers can be temporarily situated on an existing kitchen surface during use and adapted to draw power from standard 15-amp, 120-V outlets. When cooking has been completed, the deep fryer can then be removed from the kitchen surface and stored in an out-of-the-way location for later use.

A drawback of existing countertop deep fryers, however, is that they generally cannot be removed for cleaning and storage until the cooking oil has cooled to a safe temperature. As a result, a deep fryer that has been used to cook foods should be left in place for a period of time for the cooking oil to cool. With conventional deep fryers, it is commonly found that cooking oil may take several hours to cool from an operational temperature to a temperature in which the cooking oil can be safely handled. During this time, the deep fryer occupies valuable space within the kitchen, often delaying the preparation of other food items as well as delaying clean up and storage of the deep fryer. In addition to space issues, the longer the deep fryer remains on the countertop increases the potential for inadvertent exposure to the hot cooking oil.

Therefore, there is a need in the industry for a countertop deep fryer that reduces the amount of time during which the device should remain undisturbed so that the heated cooking oil can be allowed to cool and the harmful risks associated with heated cooking oil are appropriately reduced. In particular, there is a need in the industry for accelerating the cooling process of the cooking oil used in countertop deep fryers.

### SUMMARY OF THE INVENTION

Embodiments of the present invention address the above-mentioned needs of the industry by providing apparatuses and methods for reducing the amount of time during which a food preparation device that can be used to fry foods should remain undisturbed so that the heated cooking oil can be allowed to cool and the potential risks associated with heated cooking oil are appropriately reduced. Although various embodiments of the present invention may be used for any number of purposes, the apparatuses and methods are generally directed to countertop deep fryers used to deep fry foods.

In an embodiment of the present invention, a food preparation apparatus comprises a basin, a shell and a cooling device. The basin generally has a plurality of inner sidewalls and an inner base to form a liquid container adapted to receive and retain a cooking oil. The shell generally includes a plurality of outer sidewalls and an outer base. The shell generally defines a top opening for receiving the basin. With the basin inserted within the top opening, an airflow channel is defined between the inner sidewalls and outer sidewalls. The airflow channel is connected to an intake opening and an exhaust opening positioned in the shell. A cooling device interfaces with the intake opening to create a flow of air into the intake opening, through the airflow channel, and out the exhaust opening to accelerate cooling of heated cooking oil within the basin.

In another embodiment of the present invention, a method for accelerating cooling of cooking oil in a deep fryer is disclosed. The method can comprise the step of defining an airflow channel between an exterior shell and an internal oil basin of the deep fryer. The method can further comprise drawing ambient air through an intake opening in the exterior shell, directing the air past the internal oil basin to remove heat energy from the internal oil basin and discharging the now heated air through an exhaust opening in the exterior shell. In some embodiments, the step of directing the air past the internal oil basin can further comprise the step of directing the air in a substantially horizontal direction. The method can further comprise the step of maintaining the cooling air flow until a cooking oil within the internal oil basin reaches a safe handling temperature. In some embodiments, the method for accelerating cooling of the cooking oil from an operational frying temperature to the safe handling temperature can be accomplished in less than about 60 minutes. In some presently preferred embodiments, the method for accelerating cooling of the cooking oil can be accomplished in less than about 30 minutes.

The above summary of the various aspects of the disclosure is not intended to describe each illustrated embodiment or every implementation of the invention. The figures in the detailed description that follow more particularly exemplify these embodiments.

### BRIEF DESCRIPTION OF THE DRAWINGS

The embodiments of the present invention may be more completely understood in consideration of the following detailed description of various embodiments in connection with the accompanying drawings, in which:

FIG. 1 is a front, perspective view of a countertop deep fryer according to an embodiment of the present invention.

FIG. 2 is a rear, perspective view of the countertop deep fryer depicted in FIG. 1.

FIG. 3 is a perspective view of the countertop deep fryer of FIG. 1 in a disassembled arrangement.

FIG. 4 is a partially hidden, front perspective view of the countertop deep fryer depicted in FIG. 1 with arrows illustrating a cooling air flow.

FIG. 5 is a partially hidden, perspective section view of a portion of the countertop deep fryer depicted in FIG. 1 with arrows illustrating a cooling air flow.

FIG. 6 is a partially hidden, perspective section view of a portion of the countertop deep fryer depicted in FIG. 1 with arrows illustrating a cooling air flow.

FIG. 7 is a partially hidden, perspective section view of a portion of the countertop deep fryer depicted in FIG. 1 with arrows illustrating a cooling air flow.

FIG. 8 is a front perspective view of a countertop deep fryer according to an embodiment of the present invention.

FIG. 9 is a front perspective view of the countertop deep fryer depicted in FIG. 8 with an attached cooling assembly.

FIG. 10 is a partially hidden, perspective section view of a portion of the countertop deep fryer depicted in FIG. 8 with arrows illustrating a cooling air flow.

FIG. 11 is a partially hidden, perspective section view of a portion of the countertop deep fryer depicted in FIG. 8 with arrows illustrating a cooling air flow.

FIG. 12 is a rear, perspective view of the countertop deep fryer depicted in FIG. 8.

FIG. 13 is a rear, perspective view of the countertop deep fryer depicted in FIG. 8.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

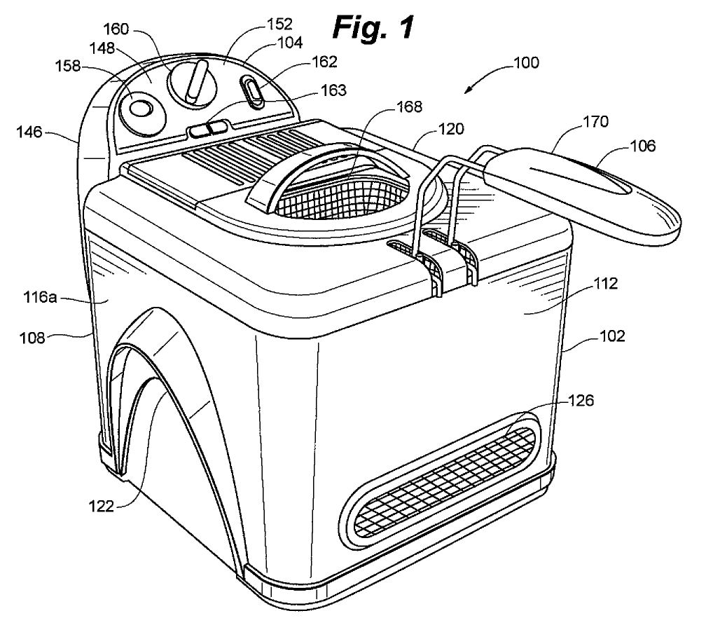

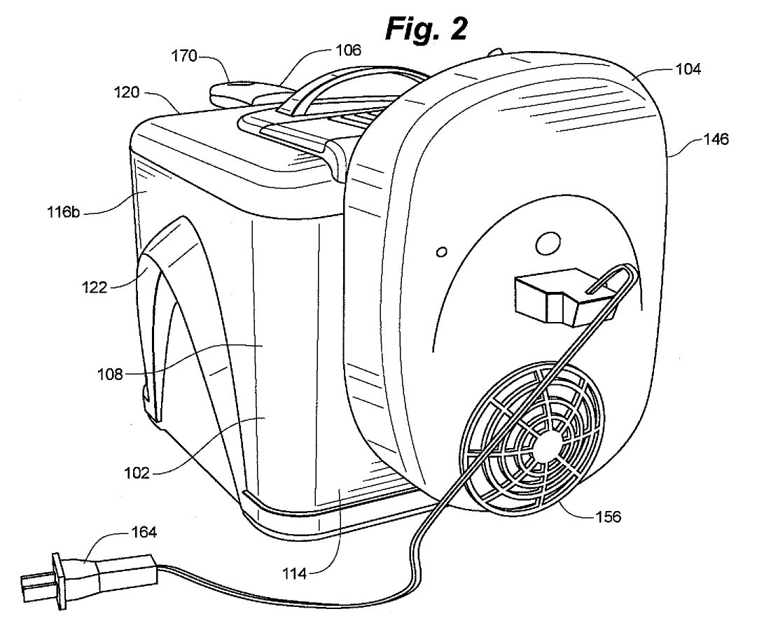

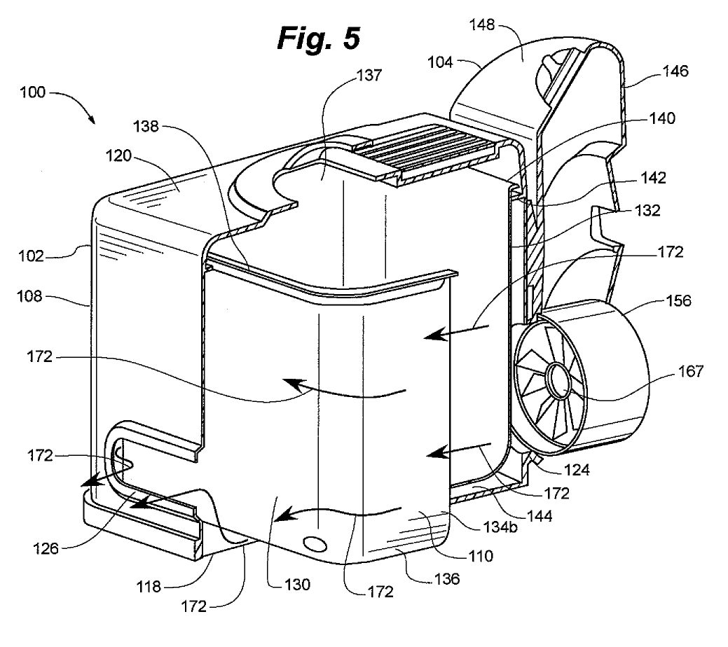

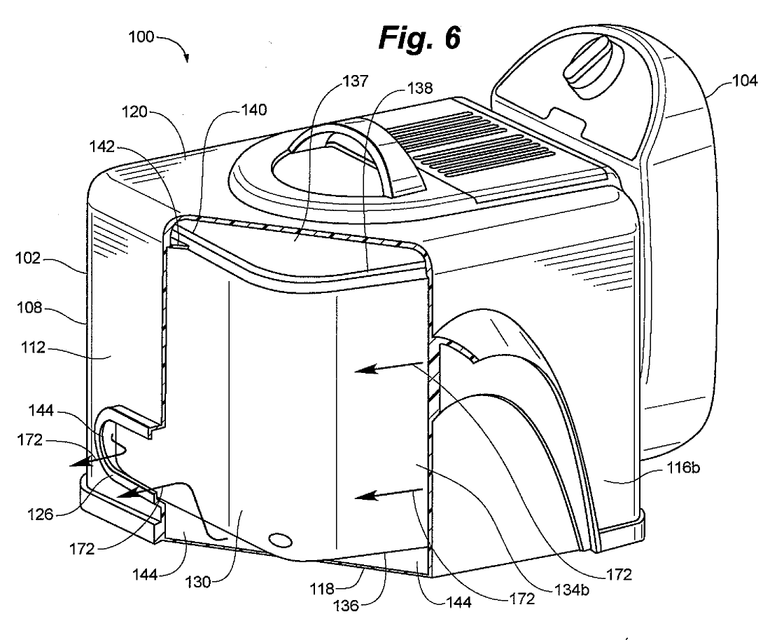

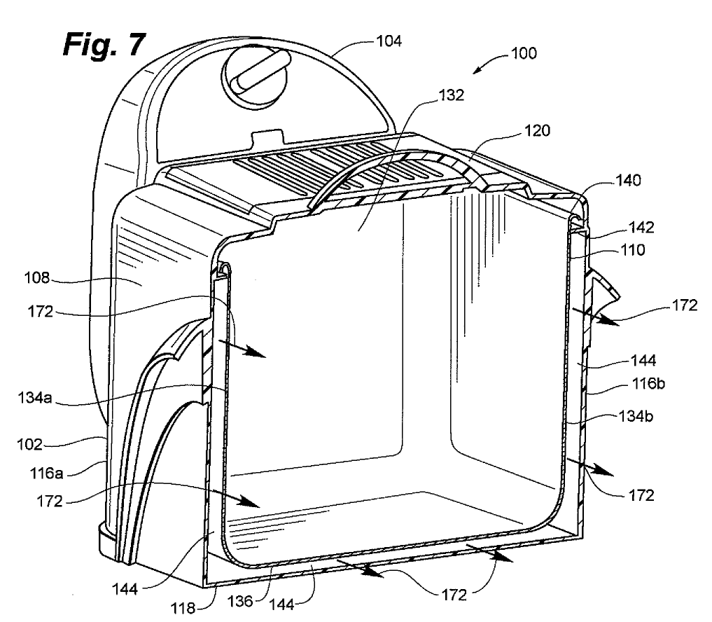

As illustrated in FIGS. 1-7, a representative embodiment of a countertop deep fryer is depicted generally with reference numeral 100. Generally, countertop deep fryer 100 can be used to prepare food through the technique of deep frying. Countertop deep fryer 100 generally includes a body assembly 102, a control assembly 104 and a food handling basket 106. The materials used to construct countertop deep fryer 100 can include any of the variety of material suitable for exposure to elevated temperatures as well as for contact with food. Representative materials can include, for example, metals such as stainless steel, aluminum and copper as well as various plastic and ceramic materials.

Body assembly 102 generally includes an exterior shell 108 and a basin 110. Exterior shell 108 is generally defined by a front wall 112, a rear wall 114, side walls 116a, 116b, a base 118 and a cover 120. Exterior shell 108 can further comprise additional convenience features such as, for example, handles 122. Exterior shell 108 can further include an inlet opening 124 and an exhaust opening 126. Inlet opening 124 and exhaust opening 126 can be located in a variety of locations on exterior shell 108 such as, for example, on opposing walls such as front wall 112 and rear wall 114 as shown in FIGS. 1-7. Alternatively, inlet opening 124 and exhaust opening 126 can be located on adjacent walls or even the same wall. In some circumstances, it may be advantageous to position the exhaust opening 126 on the base 118. Inlet opening 124 and exhaust opening 126 can comprise a variety of geometries such as, for example, a circular or elongated geometry. Generally, a mounting plate 128 is located proximate the inlet opening 124. With cover 120 removed, shell 108 generally defines an opening adapted to receive the basin 110.

Basin 110 generally comprises a liquid tight structure suitable for receiving a cooking oil. In some embodiments, basin 110 can have a liquid-holding capacity of between approximately 1.0 quarts (qts) and 20 qts. In one representative embodiment, basin 110 can have a liquid-holding capacity of approximately 4.2 quarts. Basin 110 is generally defined by a basin front wall 130, a basin rear wall 132, basin side walls 134a, 134b and a basin floor 136. Basin front wall 130, basin rear wall 132 and basin side walls 134a, 134b generally define a basin opening 137 having a basin perimeter 138. A basin exterior lip 140 extends from basin perimeter 138. Basin perimeter 138 is generally sized such that basin 110 can be placed into exterior shell 108 with basin exterior lip 140 residing on an upper wall surface 142 of the exterior shell 108. With basin 110 placed within the exterior shell 108, an insulating gap 144 is defined between the corresponding walls and floor of the basin 110 and exterior shell 108. The dimensions of insulating gap 144 can vary depending upon the overall size and capacity of the countertop deep fryer 100. In some representative embodiments, insulating gap 144 can range from about 0.01 inches to about 2.0 inches. Insulating gap 144 may vary at differing locations on the countertop deep fryer 100, for instance, the insulating gap 144 can be larger between corresponding walls than between the basin floor 136 and the base 118.

Control assembly 104 generally includes a control body 146 having an operational surface 148 and a mounting surface 150. Control assembly 104 further includes an operational assembly 152, a heating assembly 154 and a cooling assembly 156. Operational assembly 152 can include one or more of a timer assembly 158, a temperature control assembly 160, a power switch 162, one or more indicator or status lights 163 and a power cord 164. In a preferred embodiment, power switch 162 can comprise a three-position switch for selecting operational modes including a heating mode, an off mode and a cooling mode. Status lights 163 can provide a visual indication of a mode of operations such as heating or cooling and can indicate when power cord 164 is attached to a power source. Heating assembly 154 generally comprises a resistance heating element 166. Cooling assembly 156 generally comprises a fan assembly 167 mounted with the control body 146. Though not illustrated, it will be understood that various electrical components including, for example, terminals, fuses wiring, temperature sensing devices and the like necessary for safe and successful operation of the countertop deep fryer 100 are present as part of the control assembly 104.

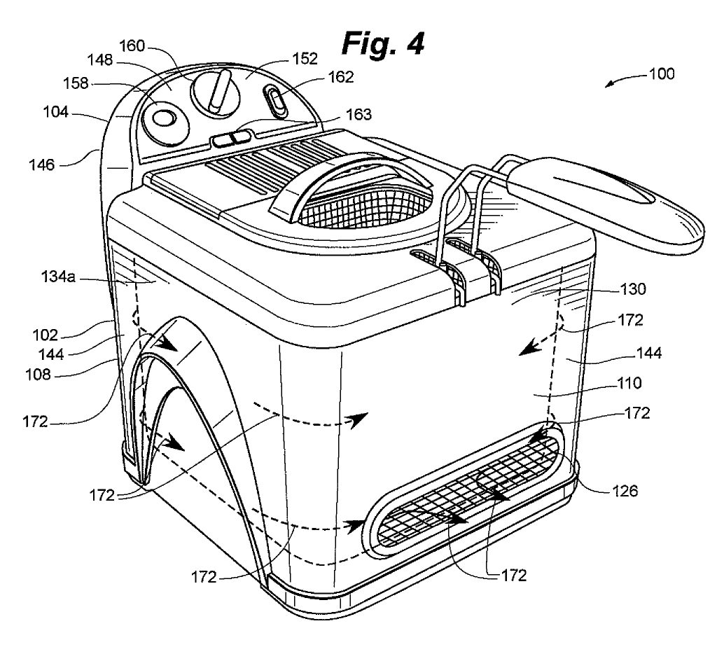

Food handling basket 106 generally comprises a mesh basket 168 and a handle member 170. Mesh basket 168 is generally sized for convenient placement into the basin 110. In some embodiments such as shown in FIGS. 1 and 4, cover 120 can be adapted to receive and retain handle member 170 during frying of food contained with the mesh basket 168.

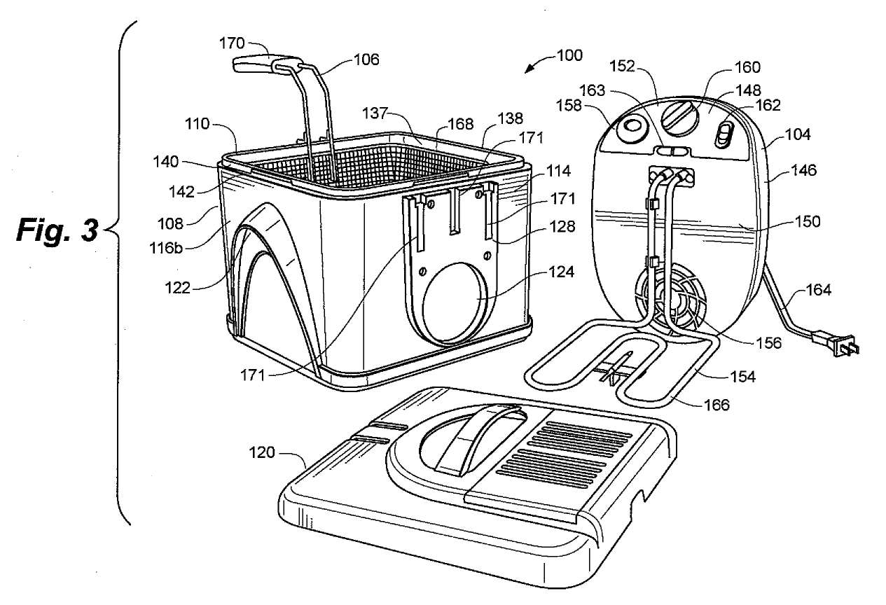

Prior to using countertop deep fryer 100, control assembly 104 is attached to the exterior shell 108 as shown in FIGS. 1, 2 and 4. Mounting surface 150 is positioned proximate the rear wall 114 such that the control body 146 can be attached to the mounting plate 128. Preferably this is accomplished through the use of quick-connect style attachment features such as, for example tabs, channels or grooves 171 as shown in FIG. 3. With control assembly 104 operably connected to the exterior shell 108, resistance heating element 166 resides within basin 110 and fan assembly 167 is located proximate the inlet opening 124.

In operation, a user generally places basin 110 within the exterior shell 108 and adds a desired amount of cooking oil. Depending upon the food to be fried and whether said food is already thawed or frozen or partially frozen, the user plugs power cord 164 into an available outlet and utilizes temperature control assembly 160 to set a desired frying temperature. The user can direct the power switch 162 to the heating mode to initiate heating using heating assembly 154. Common frying temperatures range from about 345° to about 400° F. Once the cooking oil has reached the desired temperature, which can be indicated via temperature control assembly 160 or an indicator light on operational surface 148, the user places handling basket 106 into basin 110 with cover 120 positioned on the exterior shell 108 as shown in FIGS. 1 and 4, wherein any food within the mesh basket 168 begins frying. After a desired frying time, handling basket 106 is removed from the basin 110 with the now fried food ready for consumption.

Once the user has completed deep frying food, the user can direct power switch 162 to the cooling mode wherein cooling assembly 156 can commence operation to facilitate accelerated cooling of the heated cooking oil. Using power switch 162 having distinct settings for both the heating mode and cooling mode eliminates the potential that both heating assembly 154 and cooling assembly 156 can be simultaneously initiated. With power switch 162 directed to the cooling mode, fan assembly 167 essentially pushes a cooling air flow 172 (graphically illustrated as a sequence of arrows in FIGS. 4-7) into inlet opening 124, through the insulating gap 144 and out exhaust opening 126. Cooling air flow 172 is in contact with basin 110 along basin front wall 130, basin rear wall 132, basin side walls 134a, 134b and basin floor 136. The air introduced by fan assembly 167 is at ambient temperature and begins to draw heat conducted through the basin 110 by the cooking oil. As the cooling air flow 172 leaves exhaust opening 126, the exiting air temperature is elevated as compared to the ambient air temperature. Cooling air flow 172 can be continually drawn through the inlet opening 124 and the exhaust opening 126 for a desired time period or until a measured temperature of the cooking oil falls below a specified minimum temperature, such as, for example 150° F. or lower. Once the cooking oil has cooled sufficiently, countertop deep fryer 100 can be disassembled for disposal of the used cooking oil and to properly clean the components. For example, control assembly 104 can be detached from the mounting plate 128 and cover 120 can be removed such that basin 110 can be lifted from the exterior shell 108.

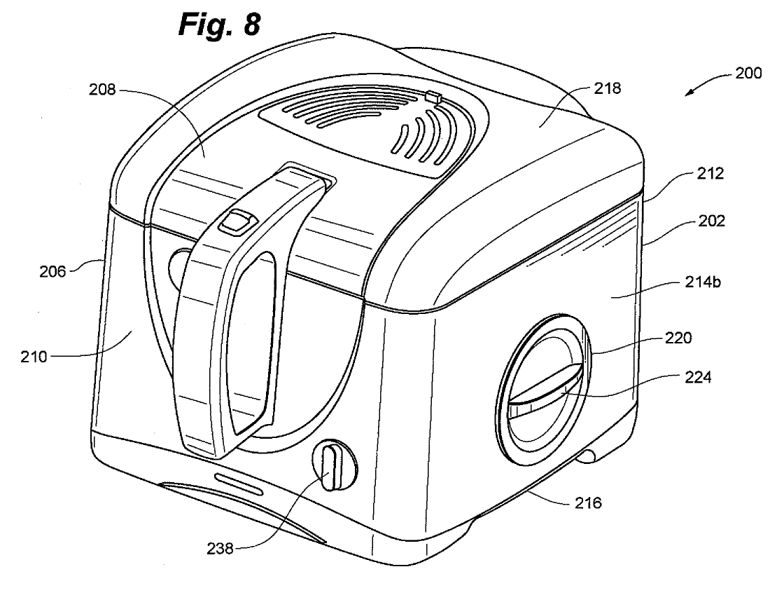

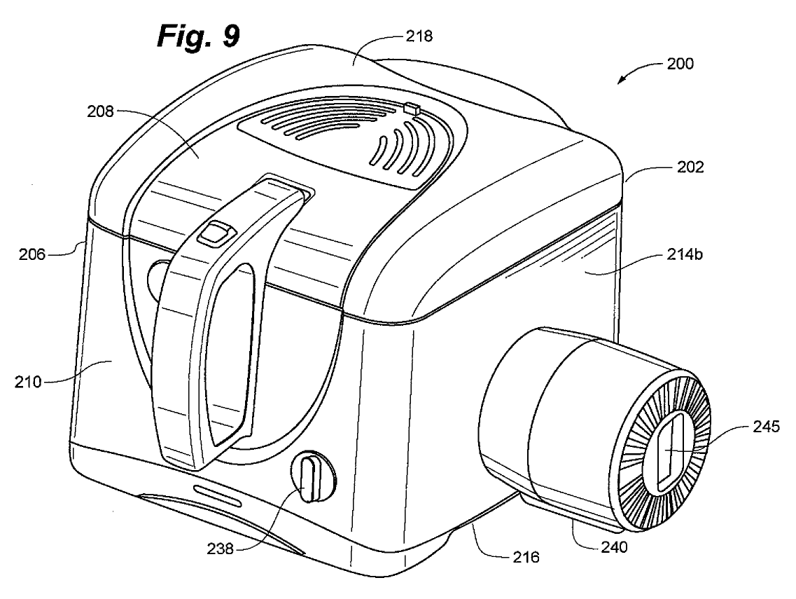

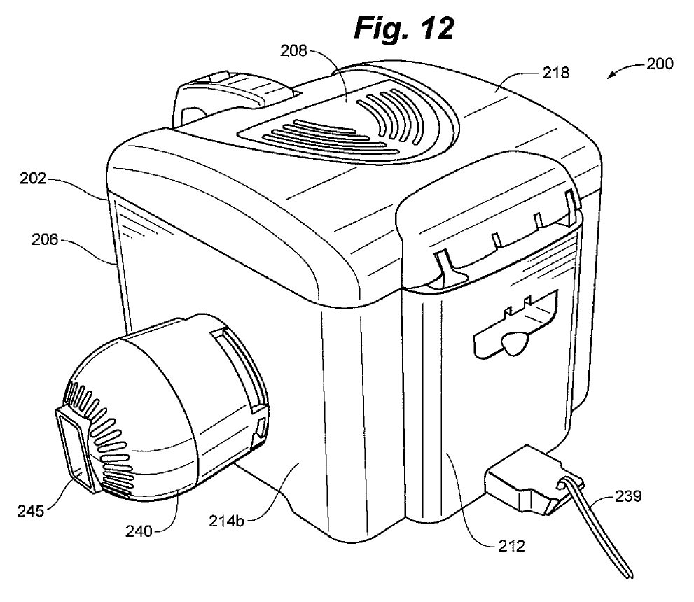

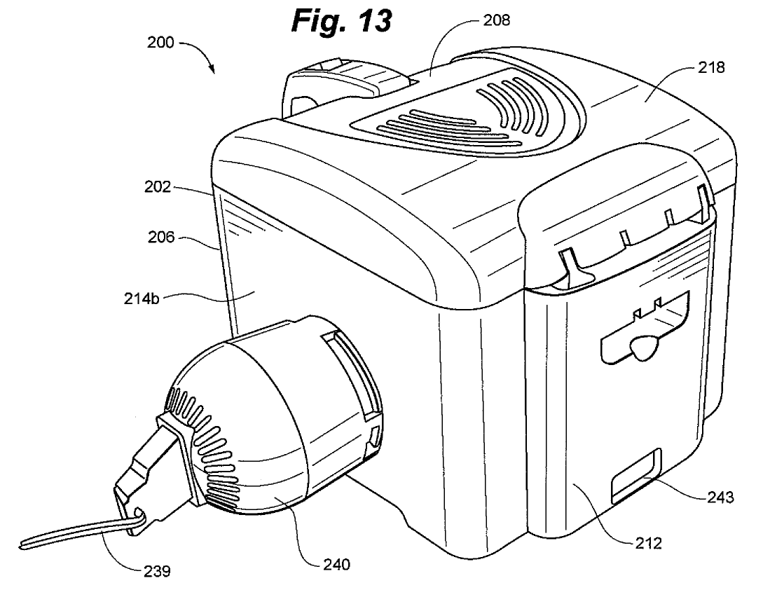

Referring now to FIGS. 8-13, another representative embodiment of countertop deep fryer 200 is illustrated. Countertop deep fryer 200 shares many of the same components and is operationally similar to countertop deep fryer 100. Countertop deep fryer 200 comprises a substantially unitary body 202 in which a basin 204 is substantially permanently mounted within an exterior shell 206. Unitary body 202 further includes a lid assembly 208 that can be removably or pivotally attached to exterior shell 206 so as to provide access to the basin 204.

Exterior shell 206 is generally defined by a front wall 210, a rear wall 212, side walls 214a, 214b, a base 216 and a top surface 218. Exterior shell 206 includes an inlet opening 220 and an exhaust opening 222. Inlet opening 220 and exhaust opening 222 can be located in a variety of locations on exterior shell 206 such as, for example, on opposing walls such as side walls 214a and 214b as shown in FIGS. 8-13. Alternatively, inlet opening 220 and exhaust opening 222 can be located on adjacent walls or even the same wall. In some circumstances, it may be advantageous to position the exhaust opening 222 on the base 216 or top surface 218. Inlet opening 220 can include a removable cover 224 to close off the inlet opening 220 when not in use.

Basin 204 generally comprises a liquid tight structure suitable for receiving a cooking oil. Basin 204 can have a liquid-holding capacity of between approximately 1.0 quarts (qts) and 20 qts. In one representative embodiment, basin 204 can have a liquid-holding capacity of approximately 4.2 quarts. Basin 204 is generally defined by a basin front wall 226, a basin rear wall 228, basin side walls 230a, 230b and a basin floor 232. Basin front wall 226, basin rear wall 228 and basin side walls 230a, 230b generally define a basin opening 234. Basin 204 is generally permanently mounted within the exterior shell 206 so as to define an insulating gap 236 between the corresponding walls and floor of the basin 204 and exterior shell 206. The dimensions of insulating gap 236 can vary depending upon the overall size and capacity of the countertop deep fryer 200. In some representative embodiments, insulating gap 236 can range from about 0.01 inches to about 2.0 inches. Insulating gap 236 may vary at differing locations on the countertop deep fryer 200, for instance, the insulating gap 236 can be larger between corresponding walls than between the basin floor 232 and the base 216.

Countertop deep fryer 200 further comprises a control assembly having many of the same components as countertop deep fryer 100 with the exception that many of the control elements are permanently mounted within the unitary body 202 and not depicted such as, for example, the resistive heating element. Countertop deep fryer 200 can comprise a temperature control assembly 238, a power cord assembly 239 and a cooling assembly 240. Cooling assembly 240 can comprise a fan assembly 242 specially adapted for removable attachment to the inlet opening 220 once the removable cover 224 has in fact been removed. Through the use of cooling assembly 240, the overall storage space required for countertop deep fryer 200 can be reduced. Power cord assembly 239 is preferably detachable for selectable attachment to either a heating receptacle 243 for powering the heater assembly (not shown) or a fan receptacle 245 on the cooling assembly 240. By selectively attaching the power cord assembly 239 to either the heating receptacle 243 or the fan receptacle 245, simultaneous operation of both the heater assembly and cooling assembly 240 is avoided.

Generally, use and operation of the countertop deep fryer 200 is similar to countertop deep fryer 100. During heating and frying of food, power cord assembly 239 is attached to heating receptacle 243 for powering the heater assembly. During cooling of the cooking oil, power cord assembly is attached to the fan receptacle for powering the cooling assembly 240. During cleanup of the countertop deep fryer 200, basin 204 is not removable from exterior shell 206. In addition, the user attaches cooling assembly 240 to the inlet opening 220 prior to commencing cooling of heated cooking oil and removes cooling assembly 240 from inlet opening 220 prior to storing the countertop deep fryer 200.

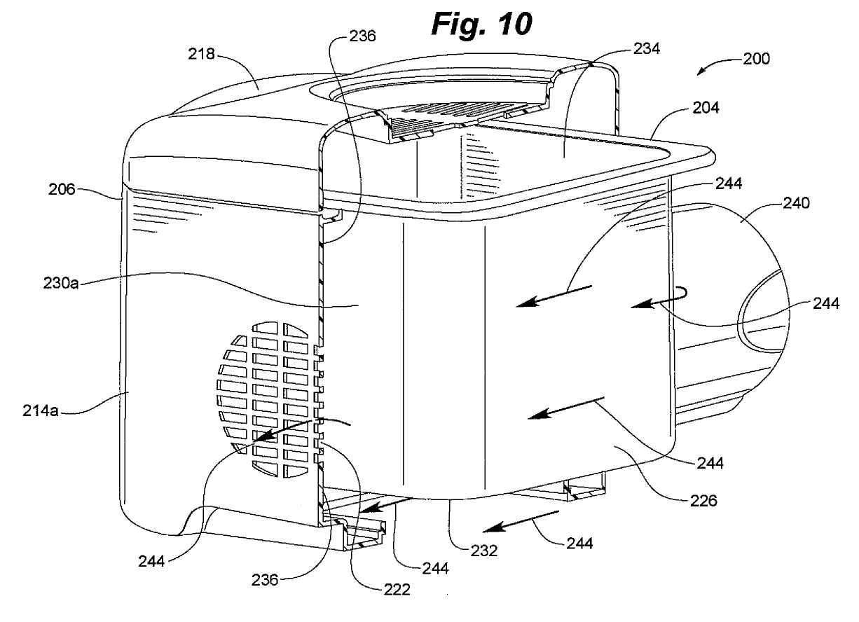

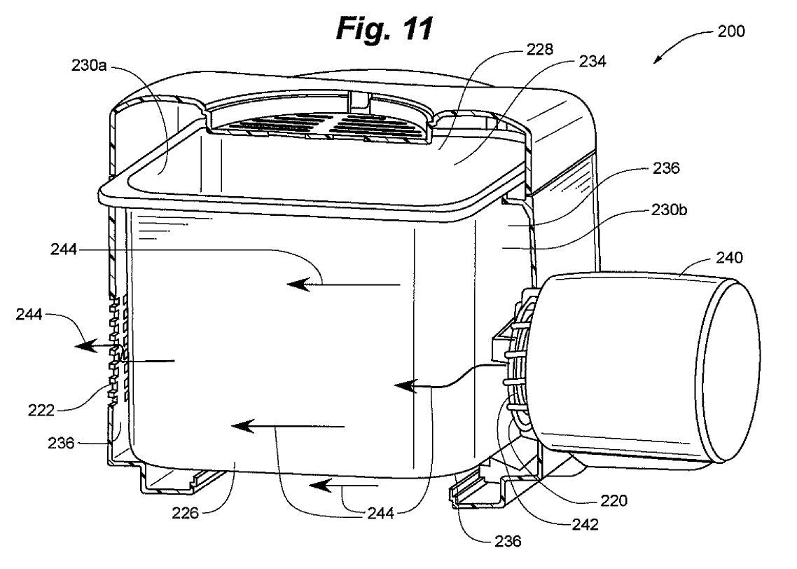

As illustrated in FIGS. 10 and 11, operation of cooling assembly 240 initiates a cooling air flow 244 (graphically illustrated as a sequence of arrows in FIGS. 10 and 11) from the inlet opening 220, through the insulating gap 236 and out the exhaust opening 222. Cooling air flow 244 is in contact with basin 204 along basin front wall 226, basin rear wall 228, basin side walls 230a, 230b and basin floor 232. The air introduced by fan assembly 242 is at ambient temperature and begins to draw heat conducted through the basin 204 by the cooking oil. As the cooling air flow 244 leaves exhaust opening 222, the exiting air temperature is elevated as compared to the ambient air temperature. Cooling air flow 244 can be continually drawn through the inlet opening 220 and the exhaust opening 222 for a desired time period or until a measured temperature of the cooking oil falls below a specified minimum temperature, such as, for example 150° F. or lower. Once the cooking oil has cooled sufficiently, cooling assembly 240 can removed from inlet opening 220 and countertop deep fryer 200 can be cleaned prior to storage of the countertop deep fryer 200.

### Testing

In order to verify the increased cooling capacities of countertop deep fryer 100 and countertop deep fryer 200, testing was conducted in which cooling rates for a conventional deep fryer using ambient cooling as the only cooling mechanism was compared to countertop deep fryer 200 utilizing a fan assembly to introduce a cooling air flow through an insulation gap. The fan assembly utilized a 12 volt, DC motor having a maximum current draw of 2.5 mA. In each case, a 4.2 quart deep fryer was used to heat corn oil to 375° F. Upon reaching 375° F., the heating element was disabled and the temperature of the corn oil was continually measured until the corn oil reached a temperature of 150° F.

For the conventional deep fryer using ambient cooling, the time required to cool from 375° F. to 150° F. exceeded two hours. For countertop deep fryer 200 utilizing a cooling air flow through the insulation gap, the time required to cool from 375° F. to 150° F. was less than one hour. As such, it can be seen that countertop deep fryers of the present invention are capable of reducing cooling times by at least about 50% in comparison to conventional countertop deep fryers.

It will thus be seen according to the present invention a countertop deep fryer and method of cooling the cooking oil in a countertop deep fryer have been disclosed. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A food preparation apparatus comprising:
a basin having a plurality of sidewalls and a floor, the basin defining an opening for receiving a cooking oil;
a shell having a plurality of outer sidewalls and a base, the shell adapted to receive the basin so as to define an insulation gap between corresponding walls of the basin and the shell, the shell further including an inlet opening and an exhaust opening in communication with the insulation gap; and
a cooling assembly adapted to introduce a cooling air flow into the inlet opening, through the insulation gap and out the exhaust opening wherein said cooling air flow accelerates cooling of the cooking oil through interaction of the cooling air flow with the basin.

2. The food preparation apparatus of claim 1, wherein the inlet opening is located on an outer sidewall opposite the exhaust opening.

3. The food preparation apparatus of claim 1, wherein the inlet opening is adapted to receive the cooling assembly.

4. The food preparation apparatus of claim 1, wherein the cooling assembly is mounted within a control assembly, the control assembly being selectively attachable to the shell such that the cooling assembly is proximate the inlet opening.

5. The food preparation apparatus of claim 4, wherein a heating assembly is operably attached to the control assembly.

6. The food preparation apparatus of claim 1, wherein the basin is slidingly removable from the shell.

7. The food preparation apparatus of claim 1, wherein the cooling assembly increases a cooling rate of the cooking oil by greater than 50% as compared to ambient cooling.

8. The food preparation apparatus of claim 1, wherein the cooling assembly introduces the cooling air flow to the inlet opening in a first direction and the cooling air flow exits through the exhaust opening in the first direction.

9. The food preparation apparatus of claim 1, wherein the insulation gap defines a distance between corresponding walls of the shell and the basin of between about 0.01 inches to about 2.0 inches.

10. A method for accelerating cooling of a heated cooking oil in a deep fryer, comprising:
defining an insulation gap between corresponding walls of a basin and an exterior shell, the insulation gap fluidly connecting an inlet opening and an exhaust opening located in the exterior shell;
forcing ambient air through the intake opening to define a cooling air flow within the insulation gap;
conducting heat from the cooking oil through the basin and into the cooling air flow to form a heated air flow; and
discharging the heated air flow through the exhaust opening.

11. The method of claim 10, further comprising:
terminating the cooling air flow upon the cooking oil reaching a desired cooled oil temperature.

12. The method of claim 11, wherein the heated cooking oil has an initial heated temperature of at least about 350° F. and wherein the desired cooled oil temperature is less than about 150° F.

13. The method of claim 12, wherein the steps of forcing the ambient air into the inlet opening to define the cooling air flow, conducting heat from the cooking oil, discharging the heated air flow and terminating the cooling air flow at a desired cooled oil temperature less than about 150° F. is performed in less than about one hour.

14. The method of claim 10, further comprising:
terminating the cooling air flow after the cooling air flow has been introduced to the insulation gap for a desired period of time.

15. The method of claim 14, wherein the desired period of time is less than about one hour.

16. The method of claim 10, further comprising placing a cooling assembly proximate the inlet opening.

17. The method of claim 10, wherein defining the insulation gap includes defining the insulation gap between corresponding floors of the basin and the exterior shell.
